(19) United States
(12) Patent Application Publication
(10) Pub. No.: US 2009/0113796 A1
(43) Pub. Date: May 7, 2009

(54) COMPACT, SPACE-SAVING ARRANGEMENT OF MICROCHANNEL STEAM REFORMING REACTORS WITH IMPROVED PERFORMANCE

(75) Inventor: Greg A. Whyatt, West Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute

(21) Appl. No.: 11/936,424

(22) Filed: Nov. 7, 2007

(51) Int. Cl. C01B 3/24; B01J 8/00

(52) U.S. Cl. 48/127.9; 48/198.3

(57) ABSTRACT

A highly compact reforming system made up of arrangements of individual reactor panels interconnected by a joint piece. This arrangement allows for a compact reforming system to be created while still retaining the low pressure drop characteristic of the panel configuration of the steam reforming reactors. In addition, the performance of a series of reactors is improved by incorporating a mixing process into the joint pieces used between panels to form the structure.

### BACKGROUND OF THE INVENTION

The present invention relates to fuel processing technologies and more particularly to steam reforming configurations for use in fuel cell embodiments.

In steam reforming of hydrocarbon fuels to generate reformate suitable for use in a fuel cell system, reactor panels are many times utilized to accomplish the desired reactions of preselected materials in the presence of catalysts to obtain a desired end product. Various configurations of these reforming panels exist each with various advantages and disadvantages. The present invention is a novel reformer assembly that allows for increased function of reformer panels in a decreased space. This provides various advantages over the typically planar arrangement of reactor panels that exist in the prior art.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 is a top plan view of a first preferred embodiment of the present invention

FIG. 2 is perspective view of the embodiment of the invention shown in FIG. 1.

FIG. 3 is side perspective view of a reformer panel of the present invention.

FIG. 4 is a cut away view of the joint piece of the present invention.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

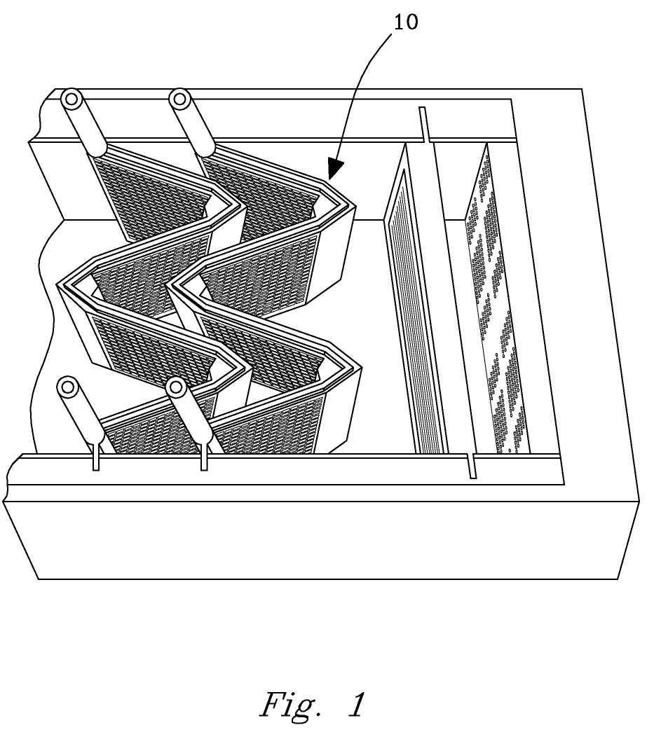

Referring now to FIGS. 1-4 a variety of views of the preferred embodiment of the present invention are shown. The present invention consists principally of two concepts that may be embodied either separately or together. While the preferred embodiment of the invention includes descriptions of these two features together in the same embodiment, it is to be distinctly understood that the invention is not limited thereto but may be variously embodied according to the respective needs and necessities of a user.

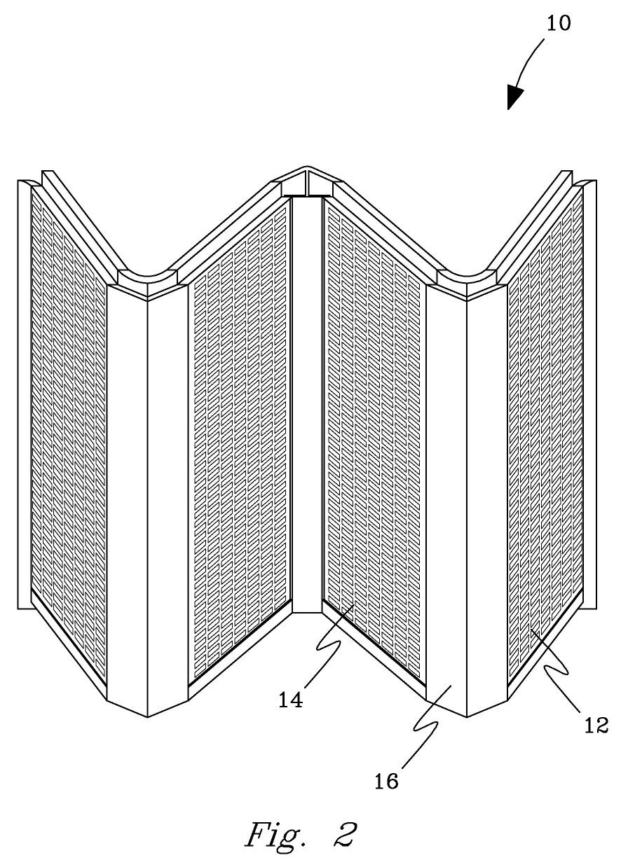

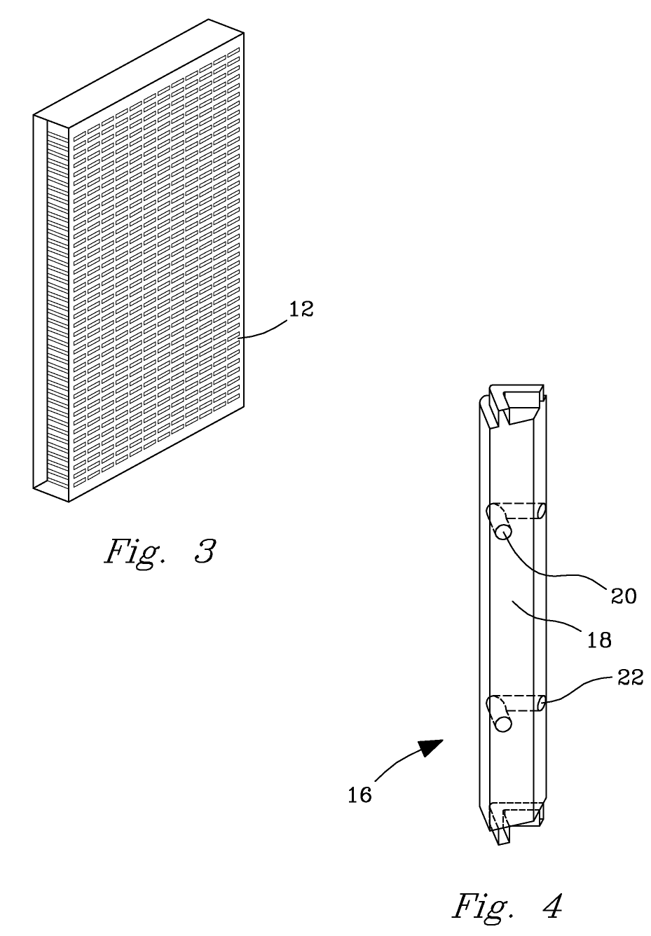

FIGS. 1 and 2 show a preferred embodiment of the present invention wherein a W shaped configuration of reactor assemblies 10 is shown. Each of these reactor assemblies is made up of at least two steam reforming reactor panels 12, 14 that are interconnected by a joint piece 16. Detailed views of the reactor panels 12, 14 and the joint piece 16 are shown in FIGS. 3 and 4. Each of these reactor panels 12, 14 comprise a series of channels through which reforming of materials can take place. In the configuration of the preferred embodiment that is described herein, material from a first reactor panel 12 enters as a reactant and exits as an effluent.

In the preferred embodiment of the invention a first reformer panel 12 is operably connected to a second reformer panel 14 through a joint connection piece 16. This joint connection piece 16 contains one or more passageways 20, 22 that are operably and functionally interconnected to the first and second reforming panels 12, 14. In use material, typically an effluent form a first reformer panel 12, enters into the joint piece 16 through one or more passageways 20, 22, and is mixed as it flows through the passageways in the joint piece 16 before exiting into a second or subsequent reformer panel 14 whereupon further processing or transformation of the material may take place. Depending upon the exact needs and necessities of the user, a variety of arrangements can be arrived at including the W shaped arrangement that is shown in the attached drawings. However, it is to be distinctly understood that a variety of other configurations that include this primary and basic feature may also be utilized. These include, but are not limited to, arrangements that include at least one V arrangement together with any other partial combination or repetition of this basic shape. Such embodiments would include but are not limited to arrangements such as V, VI, W, WI, and combinations, alterations, and repetitions thereof.

The inclusion of a pleated arrangement of reforming panels provides a more compact reforming system while retaining the desired low pressure drop characteristic of standard panel reformer configuration. The incorporation of mixing features in the joint pieces that interconnect the panels provides additional improvements in performance. The combination of these two features provides an embodiment that allows for enhanced performance in various applications.

The pleated arrangement of the preferred embodiment of the present invention reduces the velocity of reformate through the panels 12, 14 thus keeping the pressure drop low. The use of microchannel reformer panels 12, 14 provides a laminar flow of heating gases through the short dimension of the panel. In laminar flow, the heat transfer coefficient is not reduced as the velocity is reduced as it would be if flow were turbulent passing through the panel. In addition, this configuration provides a compact package while maintaining low pressure drop over the applicable area. The inclusion of a micro-channel reformer in a “panel” configuration makes it possible to use this sort of pleated arrangement for a steam reforming reactor. Individual panels, fabricated in a planar arrangement are joined with angled joint pieces to provide a pleated arrangement. In the preferred embodiment enhanced mixing occurs when two types of materials are directed toward each other in a generally perpendicular fashion.

The resulting combination creates an environment where the pressure drop is lower and the heating of the reforming catalyst is more uniform compared to a planar arrangement having the same projected cross sectional duct area and reactor structure volume (achieved by making the planar reactor thicker in the heating gas flow direction). Because the flow is laminar, the heat transfer coefficient does not decrease as the velocity is decreased in the pleated arrangement. In addition, the thin panel in a pleated arrangement retains the thin-panel's ability to utilize combustion gas temperatures significantly hotter than the reforming reaction being heated. This is due to the ability of the thin panel to effectively conduct heat between the inlet and outlet faces, providing a more uniform heating of the catalyst and preventing the heating gas inlet of the reactor from overheating.

The joint piece 16 at the apex of each pleat sets the angle of the pleat and provides for relatively easy welding of multiple panel reactors in to an assembly. However, rather than being open over a broad cross section, in this preferred embodiment only two pass-through holes or passageways 20, 22 are provided. Preferably, one is located at the middle of the bottom half, and one at the middle of the top half of the panel. Gases exiting the first reforming panel 12 are forced to recombine to pass through one of the two passageways 20, 22 in the joint piece and then redistribute in the inlet header of the next panel. The choice of the number of mixing passageways 20, 22 is made based on the velocity head of the gases in the holes and headers and the pressure drop in the panels. Depending upon the particular needs of the user, sufficient holes should be provided in order to maintain good flow distribution of the gases in the reforming panels 12, 14.

In use, the steam reformer is preferably designed to operate with no detectable non-methane hydrocarbon residual in the reformate. For a given panel, the throughput which yields 99.8% conversion is significantly higher (by ˜50%) than the conversion to achieve >99.995% conversion. This is because the throughput of the panel when operating at very high conversion levels will be determined by the poorest performing channel (in terms of quantity of unreformed residual material that is passed). Within each panel, there may be variations in the level of fuel conversion achieved in each of the 48 parallel reaction channels due to differences in the catalyst activity, catalyst thickness (which translates to flow mal-distribution), or combustion side temperature differences (which will affect temperatures and hence kinetics). When designing to achieve full conversion of the hydrocarbon with multiple panels, it is beneficial to mix the reformate at each panel inlet/outlet to even out the unconverted hydrocarbon concentration. This prevents one or two channels that are performing poorly from significantly affecting the overall throughput for the system.

In the preferred embodiment of the invention shown in FIGS. 1-4, reactor panels 12, 14 are welded to the two faces of the joint piece 16 so that the holes connect to the headers of the panels. The relative angle built into the joint piece determines the angle of the pleat. The ridges along the top aid in installation of the combustion duct liner. The present invention thus provides a highly compact reforming system while retaining the low pressure drop characteristic of the “panel” configuration of the steam reforming reactors. In addition, the performance of a series of reactors is improved by incorporating a mixing process into mixing chambers 18 located within the joint pieces 16 used between panels to form the structure.

In one preferred embodiment of the invention, reactor panel assemblies of the present invention are stacked in a series within a duct. The duct is configured so that heating gasses pass through a first assembly 10 and then a second assembly 11 while the entire quantity of reacting gases pass first through the second assembly 11 in a cross flow configuration relative to the heating gas and then, with reforming gas flowing in the same direction as flow in assembly 11, passes through the first assembly 10, also in cross flow relative to the heating gas flow. This flow arrangement allows for increased efficiency of heat transfer and reaction within the device.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A reactor device characterized by:
at least two reactor panels functionally interconnected at an angle of less than 180 degrees to form a pleated reactor assembly.

2. The assembly in claim 1 where the reactor device performs steam reforming

3. The reactor device of claim 2 further comprising at least one joint piece, interpositioned between said reforming reactor panels, said joint piece defining a mixing chamber, said combination of reactor panels and joint pieces forming a reactor assembly.

4. The reforming device of claim 3 wherein said joint piece defines at least two distinct passageways therein.

5. The reforming device of claim 1 wherein said reactor assembly has at least two joints.

6. The reforming device of claim 1 wherein said reactor assemblies has at least three joints and wherein said steam reforming reactor assembly has a general “W” shape.

7. The reforming device of claim 6 wherein said reforming device has at least two W shaped reactor assemblies arranged in a serial stacked formation.

8. A reactor device characterized by:
at least two reactor panels functionally interconnected by at least one joint piece, interpositioned between each of said two reactor panels, said joint piece defining a mixing chamber, said combination of reactor panels and joint pieces forming a reactor assembly.

9. A method for steam reforming a material in a reactor assembly, said reactor assembly comprised of at least two steam reforming reactor panels functionally interconnected at an angle of less than 180 degrees said method characterized by the steps of:
processing a first material in a first reactor panel to produce an effluent; and
processing said effluent in a second reactor panel.

10. The method of claim 9 wherein the effluent from the first reactor panel is mixed before being processed in the second reactor panel.

11. The method of claim 9 further comprising the step of heating said reactor panels with radiant and convective heat.

12. A fuel reforming reactor assembly comprising:
at least four reactor panels interconnected by at least three joint pieces to form a reactor assembly having a general W shape.

13. The reactor assembly of claim 12 wherein at least one of said three joint pieces defines a mixing chamber interpositioned between two of said panels, said mixing chamber allowing for functional passage of material between said two panels.

14. The reactor assembly of claim 12 wherein at least one of said joint pieces defines at least two distinct passageways therein.

15. The reactor assembly of claim 12 wherein said fuel reforming reactor has at least two at least 2 W-shaped reactor assemblies arranged in a stacked configuration whereby heating gas flows through the W assemblies in a first direction while reacting gases pass through said assemblies in a second direction.

16. The reactor assembly of claim 15 wherein said first direction is generally perpendicular to said second direction.
